(19) United States
(12) Patent Application Publication
(10) Pub. No.: US 2013/0030990 A1
(43) Pub. Date: Jan. 31, 2013

(54) Method of preventing disaster induced data loss

(71) Applicant: Robby Jay Moore, Auburn, CA (US)

(72) Inventor: Robby Jay Moore, Auburn, CA (US)

(21) Appl. No.: 13/507,286

(22) Filed: Jun. 19, 2012

Related U.S. Application Data
(60) Provisional application No. 61/571,252, filed on Jun. 23, 2011.

(51) Int. Cl. G06Q 30/06

(52) U.S. Cl. 705/39

(57) ABSTRACT

A cost effective method of preventing disaster induced data loss in digital data storage devices without requiring the use of a data backup service is provided. A fire resistant and water resistant digital data storage device is sold by a manufacturer to a customer wherein the customer pays an upfront payment competitive with the cost of a digital data storage device that is not fire or water resistant. A portion of the purchase price is allocated to monthly payments to be paid by the customer to the manufacturer for a data recovery service if the device is damaged by fire or water; monthly payments for the recovery service being competitive with the cost of a backup service.

### CROSS REFERENCE TO RELATED APPLICATION

This application claims the benefit of and priority from U.S. provisional application Ser. No. 61/571,252 dated Jun. 23, 2011.

### BACKGROUND

Most of the digital data stored today is unprotected by either a backup data storage service or a disaster resistant enclosure for the storage device. It has been estimated that 75% of all stored data is unprotected from disasters such as fire and flood. This is a staggering figure, in view of the fact that approximately 90% of businesses that suffer a data loss during a disaster go out of business in less than 2 years. Much of the data loss is a result of fire or water damage.

The magnitude of the effects of disaster induced data loss on businesses are summarized in a comprehensive paper entitled “IT disaster recovery: Oman and Cyclone Gonu lessons learned” published in Information Management & Computer Security, Vol. 17, No. 2, pp. 114-126 (2009). The significant conclusions reached include:

A total of 90 percent of businesses that lose data during a disaster will close their doors within two years of the event.

Of businesses without a DR [data recovery] plan, 80 percent close within 12 months of a flood or fire.

Of companies that have a BCP [business continuity plan] plan, 43 percent do not test it annually.

More that 40 percent of organizations do not have redundant servers or backup sites for critical business functions.

A total of 66 percent of US companies have not adopted or implemented US National Fire Protection Association (NFPA, 2007) standards on disaster/emergency management and business continuity.

It is significant to note that the above conclusions are limited to businesses; it is believed that digital data owned by individuals as personal data is even more vulnerable than business data.

Backup data storage service is expensive and often untested; fire and water resistant data storage devices are also expensive compared with unprotected devices. What is desperately needed is a cost effective and reliable way of protecting digital data, without requiring the owners of the data (i.e. business owners or individuals) to provide a backup data storage service.

Backup data storage services have several inherent weaknesses. First, the cost is relatively high. Second, the online services are subject to all online hazards, such as hacking, viruses and malfunction. Third, arranging a backup service requires time and effort on the part of the data owner. Fourth, and perhaps most significant, over 40% of the business users of backup data services do not annually test the service.

### BRIEF SUMMARY OF INVENTION

The present invention provides a cost effective system of protecting such data from disasters in which the data storage device is subjected to fire and water damage. The data may optionally also be protected from impact damage and crush damage.

The present invention protects digital data owned by businesses as well as personal data-owned by individuals.

In a nutshell, the present invention is a method whereby a manufacturer of disaster resistant digital data storage devices sells the device to customers on the following terms:
1) An upfront payment which is competitive with comparable devices which are not protected from fire and/or water damage.
2) The manufacturer agrees to recover data from the device for a specified period of time if the device is subjected to damage from fire or water.
3) The customer agrees at the point of purchase to pay the manufacturer a monthly fee for the specified period of time to recover the data if the device is subjected to damage from fire or water.
4) The monthly fee is competitive with online backup services, and is essentially an allocated portion of the purchase price.

The above terms provide the customer a significant protection against disaster induced data loss at a lower overall cost compared with the purchase of an unprotected storage device and a backup storage service.

A primary object of the invention is to provide a low cost system of protecting digital data against disaster induced loss.

A further object is to protect digital data without the owner of the data having to purchase a backup storage service.

Another object is to provide low cost protection of digital data owned by either businesses or individuals.

A further object is to provide low cost protection of digital data in a single transaction at the point of purchase of the digital data storage device, i.e. the purchaser does not have to go through a second transaction with a backup data storage service.

### BRIEF DESCRIPTION OF DRAWINGS

FIG. 1 is a schematic representation of a typical, two step purchase of an unprotected data storage device in step one and a separate purchase of an online data backup service; and

FIG. 2 is a schematic representation of the single step, point of sale transaction of the present invention wherein the purchaser acquires the protected storage device and data recovery service at a lower price than the two step transaction of FIG. 1.

### DETAILED DESCRIPTION OF DRAWINGS

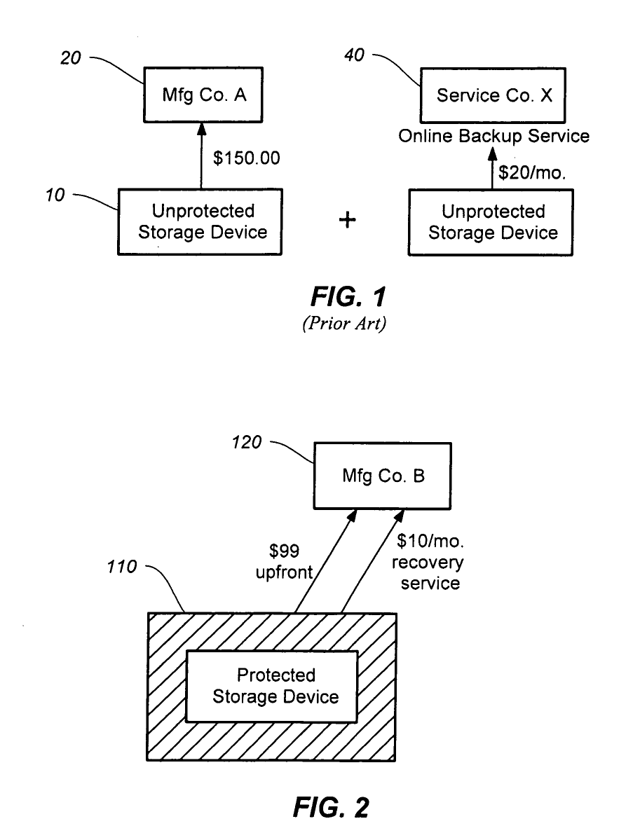

FIG. 1 illustrates a typical purchase of an unprotected 3TB storage device 10. A purchase price of $150.00 is paid to Manufacturing Company A 20. As a separate second transaction, a price of $20.00 per month is paid to Service Company X 40 for an online data storage backup service.

FIG. 2 illustrates the point of sale, single transaction of the present invention. The protected storage device 110 (resistant to fire and water damage) is purchased from Manufacturing Company B 120 for an upfront payment of $99.00 and a monthly charge of $10.00 for 5 years for data recovery if the device 110 is damaged by fire or water.

Disaster resistant hardware combined with data recovery services is a simple way for consumers and businesses large and small to put a disaster plan into effect with very little effort. Current disaster resistant hardware designs in the prior art consist of fire resistant and water resistant external hard drives such as shown in U.S. Pat. No. 7,291,784 (incorporated herein by reference) for example. Optional features known in the art include crush resistance and impact resistance for the external hard drives.

The problem with online data backup is bandwidth and the cost per GB of online data storage. Typical costs are from $1 to $5 per GB for online data storage in a remote data center. Monthly costs to store 1TB online can easily be $500.00 to $1000.00 per month per Terabyte (TB) of storage.

By combining disaster proof hardware with monthly data recovery as a service, the cost of backing and protecting onsite data plummets dramatically. For as little as $5 per month per TB, a small business (or individual) can enjoy 99.9 percent of the benefit of backing up offsite plus have greater security knowing that data might not be compromised during transmission over the internet.

A common objection for small business and consumers in purchasing disaster proof hardware is its high relative cost as compared with unprotected external hard drives or data storage. For instance, an unprotected 1 TB drive in 2011 can cost approximately $80 dollars vs. a 1 TB disaster proof external hard drive which typically costs twice as much at $160. Clearly something must be done to create wider adoption of disaster proof hardware as data loss continues to be a major reason why businesses fail post-disaster.

Unfortunately, standard insurance companies don't specialize in data recovery or data storage. They can buy a new external hard drive for you but cannot get your data back if it's consumed in a fire. As data is second only to people as a business asset, there currently exists a large gap in how data, digital pictures, video, etc. is “insured”—effectively leaving businesses and consumers unprotected for irreplaceable data.

The applicant believes that combining disaster proof hardware with monthly payments for data recovery service, is a novel system for protecting data. By combining the hardware plus services for as low as $5 per month, just about every business or individual consumer can afford to “insure” the data against loss—something that traditional insurance companies cannot do with replacement hardware alone. Standard extended warranties or data recovery policies that exist today cannot retrieve data from unprotected melted hardware regardless of the amount of money spent in recovery.

Clearly, the synergy of fire resistant and water resistant hardware combined with monthly payments for disaster recovery services is a major step towards protecting data at an affordable monthly price ($5-10 dollars) that is unique to any other offering that currently exists.

As approximately half of all computer users have lost data at some point in their experience, the need for world wide, affordable solutions exist. This novel system fills the gap that normal insurance, extended warranties and online methods leave unfilled.

A specific example is described below comparing the proposed new system with a prior art system.

A fire resistant and water resistant 3TB data storage device at various retail locations is about $580.00. The attractiveness is limited due to the relatively high price in comparison to other 3TB external hard drives on the market for as low as $149.00

The present invention proposes offering the fire resistant and water resistant hardware at a low upfront price and allocating a part of the purchase price at the point of sale to a small monthly fee for data recovery instead of having the consumer pay for the device all at once. Instead of the consumer paying $580 all at once, the consumer could pay $99 up front and $10/month for 5 years which would generate nearly $700 over the life of the product vs. approximately $400 after retailers take their fee for selling the same product for a one-time cost.

Advertising the protected device plus a low monthly fee would generate tremendous interest compared to a higher initial price of the unprotected unit for $149.

The foregoing description of the invention has been presented for purposes of illumination and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated.

What is claimed is:

1. A cost effective method of preventing disaster induced data loss in digital data storage devices caused by fire and/or water damage, without requiring a data backup service, comprising the steps,
providing a fire resistant, water resistant digital data storage device to a customer from the manufacturer of said device, wherein the purchase price includes an upfront payment and a series of monthly payments,
providing a data recovery service by or for said manufacturer whereby said manufacturer agrees for a specified period of time to recover data from said data storage device after said device has been exposed to fire and/or water damage,
allocating a portion of the purchase price of said device to said series of monthly payments to be paid by said customer to said manufacturer for said data recovery service,
whereby the upfront payment required for said fire resistant, water resistant digital data storage device is competitive with the cost of comparable digital data storage devices which are not fire resistant and/or water resistant,
whereby said monthly payments to be paid for said data recovery service is competitive with or less than the cost of a backup data storage service, and
whereby said customer has protected his data at a minimum cost and without having to have a backup data storage service.

2. The method of claim 1 wherein the data storage device is also impact resistant.

3. The method of claim 1 wherein the data storage device is also crush resistant.
